(19) United States
(12) Patent Application Publication
(10) Pub. No.: US 2010/0080626 A1
(43) Pub. Date: Apr. 1, 2010

(54) Multicolor image uniformity by reducing sensitivity to gear train drive non-uniformity

(76) Inventor: Thomas J. Foster, Geneseo, NY (US)

Correspondence Address: Andrew J. Anderson, Patent Legal Staff;Eastman Kodak Company, 343 State Street, Rochester, NY, 14650-2201, US

(21) Appl. No.: 12/284,983

(22) Filed: Sep. 26, 2008

(51) Int. Cl. G03G 15/00; G03G 15/01

(52) U.S. Cl. 399/167; 399/301

(57) ABSTRACT

A method and system for printing documents using a variety of gear arrangements and, more particularly, to a method and apparatus for printing image elements within a document to minimize print artifacts by reducing sensitivity to gear train drive non-uniformity.

### FIELD OF THE INVENTION

The present invention relates generally to printing documents with image elements and, more particularly, to a method and apparatus for printing image elements within a document to minimize print artifacts by reducing sensitivity to gear train drive non-uniformity.

### BACKGROUND OF THE INVENTION

Office printers have developed greatly over the last years, especially from black only devices focused solely on text and monochrome graphics to process color devices that emphasize color graphics and highlighting of text through the use of color. Electrophotographic printers have been developed that meet these needs admirably with low cost and high reliability. Spatial resolution and addressability in these print engines have advanced from 300 dpi (dots per inch), to 400 dpi, 600 dpi, 1200 dpi and beyond. Multiple tone resolutions per pixel (multi-bit per pixel) systems have also been developed to provide increasingly higher levels of image quality.

There is also a trend towards adding additional imaging modules to allow advanced imaging modes such as clear image layers for texturing, spot glossing, overall glossing, image protection, and addressable glossing, additional color layers for color gamut extension, pastel color reproduction without graininess, and additional image layers for security printing features, e.g. MICR printing, etc.

At the same time, customer demand for standard photographic prints has been steady or dropping, while demand for value added photoproducts such as photobooks, calendars and photo greeting cards has been rising and is projected to continue rising in the future. These increasingly desirable retail photoproducts are preferred when printed in duplex mode (on both sides of the paper), which is difficult or impossible for most silver halide and thermal photographic printing processes, but easily achieved using electrophotographic printers.

The desire for printer products that perform at near photographic quality for duplex color photograph reproduction in inexpensive print engines has pointed out image quality shortcomings in the print engines currently being produced and sold. Trends towards higher pixel resolution and higher number of levels per pixel also make to possible to see defects that previously were not resolved in EP printing. These shortcomings include sensitivity to drive uniformity variations that cause density bands on the output in the crosstrack direction (orthogonal to the direction of paper motion through the printer) on the output sheets. Such uniformity variations are very objectionable in common photographic scenes, such as those including sky, close up faces, and other areas with large areas with subtle gradations within the color palette being printed. These density variations can be much more severe in multicolor images than in the individual monochrome colors, reducing image quality below acceptable levels for near photographic color reproduction.

The desire to provide inexpensive solutions to these banding problems is large and increasing, so that customer acceptable duplex photobooks, calendars, and greeting cards can be inexpensively produced. Several methods are known for reducing drive variation induced banding in existing electrophotographic products, but each of these has significant limitations. One method that is used is active motion compensation where each exposure line is evenly spaced on the image. This method has shortcomings because it requires motion sensors with high resolution to track the motion and deliver line timing signals that correct for drive velocity variations. It is both costly and complex and not well suited to inexpensive print engines. Another expensive solution is to use improved gear quality to provide increased drive uniformity to reduce the drive non-uniformity by improving the gear tooth profiles and having multiple teeth meshed at any given time through helical gearing. This also increases the printer costs for the high quality gears that must be machined rather than molded gears, or alternatively require much more expensive moldable plastic resins to be used to make the high quality gears.

The use of one or more flywheels can be used to smooth out non-uniformity by incorporating large rotational inertia mass into the drive system. This reduces single- and multiple-color banding, but increases start up and peak torque required of system requiring larger, more expensive motors and gear trains, and increasing the time required to achieve desired process speeds.

Finally the use of a reduced tooth pitch can be used to change the frequency of the drive non-uniformity into a region where human vision is less sensitive, but this also reduces maximum torque which the drive can deliver without stripping gears unless the width of each tooth is increased or the gear material is changed, once again greatly increasing the cost of the gears used.

A need exists to provide a gear set that controls the drive gears in such a way to minimize the appearance of drive non-uniformity related banding without unnecessarily increasing the cost of the drive gears.

### SUMMARY OF THE INVENTION

The present invention provides an electrophotographic printing apparatus and method for printing documents using a variety of gear arrangements and, more particularly, to a method and apparatus for printing image elements within a document to minimize print artifacts by reducing sensitivity to gear train drive non-uniformity.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a perspective view of a drive train for an electrophotographic printer.

FIG. 2 is a perspective view of a compound gear for an electrophotographic printer.

FIG. 3 is an overlay of two compound drive gears illustrating the phase relationship between them.

FIG. 4a is a graphic illustration of the in phase relationship of the drive non-uniformity in a two color image and its effect on banding.

FIG. 4b is a graphic illustration of the 180° out of phase relationship of the drive non-uniformity in a two color image and its effect on banding.

FIG. 5 is a graph of the predicted banding amplitude vs. the phase angle for a 2 color image.

FIG. 6 is a graph of the actual subjective response to a series of prints with varying phase angle relationships.

FIG. 7 is a diagram of an example multicolor EP printer

### DETAILED DESCRIPTION OF THE INVENTION

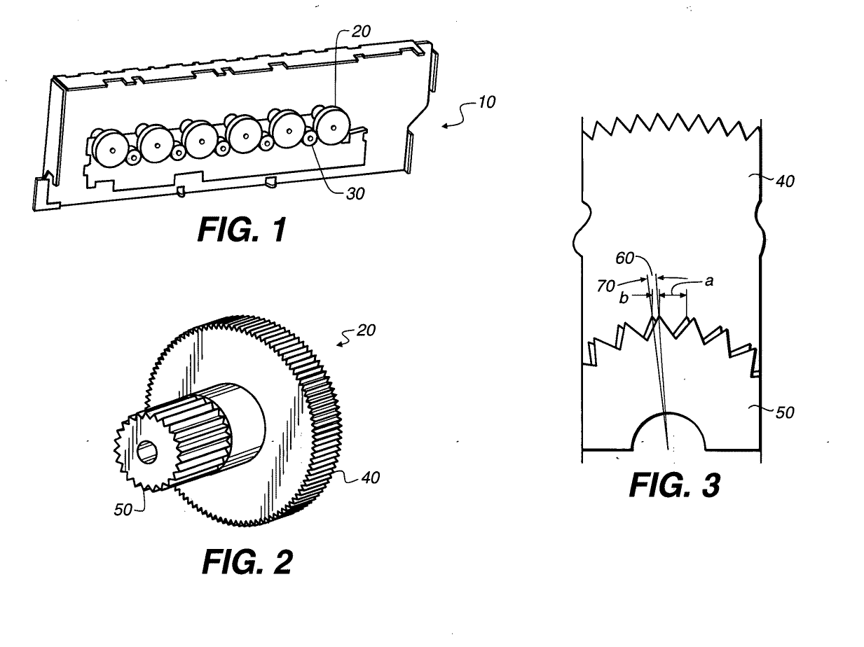

Drive non-uniformity exhibits itself as velocity variations in the direction of paper motion. For printing systems such as LED printers, the LED exposure array may run on its own clock, writing lines at fixed time intervals. In this situation, velocity variation from the drive system will cause the LED exposure lines to be closer together in areas where the drive velocity is slower, and farther apart in areas where velocity is higher. Because the LED exposure is very short in time compared to the drive velocity variations of interest, the exposed pixel will be constant in size. When these exposed areas are developed, areas of low velocity will then have higher area coverage than areas exposed during periods of high drive velocity. The average area coverage will remain correct (as long as the drive velocity average is correct) but the variations in coverage will cause visible variations in printed density at a spatial pitch on the page determined by Equation 1:

$$( P ) Spatial pitch on page = \frac{average velocity of the drive}{temporal frequency of drive variation}$$

Where multiple electrophotographic modules have the same drive source (a single drive train such as shown in FIG. 1), the variations in drive velocity are locked in phase in relation to each other, the effects for each image made of multiple colors will be additive and related to the phase between the electrophotographic modules. There is a strong desire to use identical components and assemblies in inexpensive printers for interchangeability of parts and economies of scale in manufacturing. The use of mechanically identical modules attached to a single drive train of repeating gear modules produces images at each module that are in phase with each other, and thus susceptible to severe multi-color image banding.

For a four station machine, the amplitude of the density variation will increase if the stations are in phase, making the problem much more observable. EP printers are known with 5, 6, or even 8 or more EP modules. As the number of these modules increases, avoiding in-phase imaging between modules becomes more and more important.

The invention described here controls the phase of imaging modules relative to one another in a print engine to minimize the appearance of drive non-uniformity related banding.

FIG. 1 shows a perspective view of a drive train for an electrophotographic printer including drive train (10) with multiple compound drive train gears (20) and idler drive train gears 30. The drive train will include one compound drive train gear (20) per electrophotographic module and at least one fewer idler drive train gears (30). The use of multiple electrophotographic modules enables many printing features, such as process color printing for business graphics, greeting cards, photobooks, calendars, and photographs, as well as security printing options such as magnetic ink character recognition (MICR) printing, and enhancements such as clear toners for overall or spot glossing applications onto one or two sided documents.

FIG. 2 shows a perspective view of a compound gear (20) for such an electrophotographic printer. It has a large hub (40) which is driven by a drive motor (not shown) or by an idler gear earlier in the drive assembly. In the exemplary compound gear (20) shown, this large hub (40) has 102 gear teeth around its circumference. Compound gear (20) also has a small hub (50) which directly drives an electrophotographic module (not shown). In the exemplary compound gear (20) shown, this small hub (50) has 24 gear teeth around its circumference.

FIG. 3 is a superposition of two compound drive gears (20) with the teeth of the outer hubs aligned, illustrating one of 17 possible phase relationships between the corresponding smaller hub gear teeth. The exemplary diagram shows the relationship between the small hub (50) gear teeth if the teeth of the large hub (40) are rotated one tooth out of perfect alignment of the two compound gears (20). FIG. 3 shows distances a and b for a gear drive assembly including at least two gears, a first gear having first gear teeth and a second gear having second gear teeth, each of which drives a photoconductor in a separate print engine. The first gear teeth and the second gear teeth are offset an offset value can be calculated as a distance or a phase angle from distances a and b as will be described in more detail below.

The distance (a) is the distance between gear teeth on the small hub of one compound gear and (b) is the offset distance between the gear teeth on the small hubs of the two superpositioned compound gears. These distances are used to calculate or represent the fraction of a tooth the alignment is off. The ratio b/a represents how much the two gears are off relative to one another. There are 17 such possible relationships for the compound gear shown because for every 17 teeth on the large hub (40), there are exactly 4 teeth on the small hub (50). For other compound gears, there would be other finite numbers of possible relationships, limited on the high end by the number of teeth on the large hub (40) and on the low end by one (if the number of gear teeth on the large hub (40) was equal to the number of gear teeth on the small hub (50)). The gear offset (60) between teeth of the inner hub can be described as a relative phase angle (70) between the small hub (50) gear teeth, calculated from the relationship in

θ_{(gear teeth)}=b/a*360_{(in degrees)}=b/a*2Π_{(in radians)} Equation 2

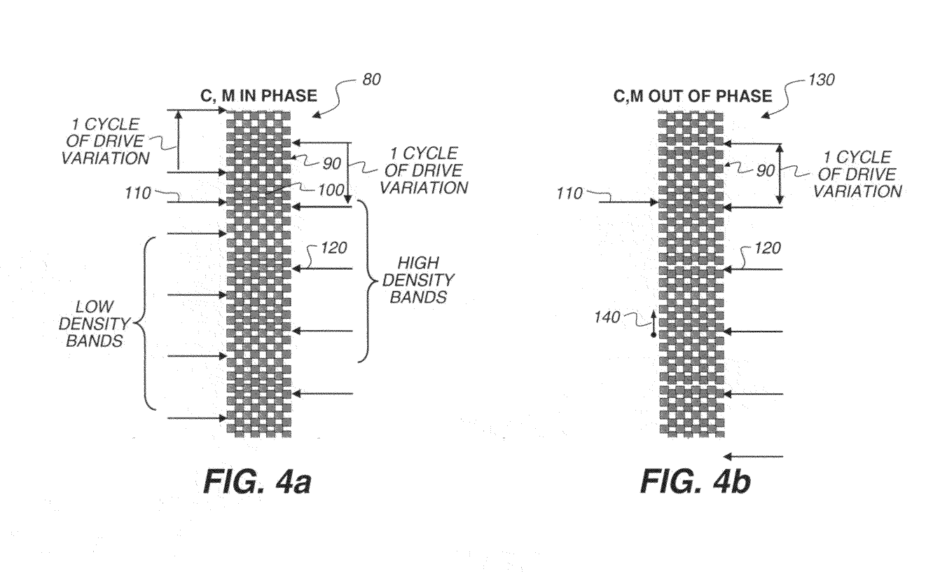

FIG. 4a shows a graphic illustration of the in phase relationship of the drive non-uniformity in a two color image and its effect on banding. A two color, in phase halftone pattern (80) of dots is shown with the period of the drive train non-uniformity (90) corresponding to the small hub (50) gear tooth frequency shown. The locations of the slowest drive velocity for color 1 (110) are shown as well as the locations of the slowest drive train velocity for color 2 (120). Because the two colors have a phase angle of 0, these two locations match. This creates more observable banding than either color would show separately, with darker bands located at the points where drive velocity is lowest (110, 120).

FIG. 4b shows a graphic illustration analogous to FIG. 4a where the phase angle between the inner hub drive gears of the two colors is 180 degrees. In this example, the locations of the slowest drive velocity for color 1 (110) are shown as well as the locations of the slowest drive train velocity for color 2 (120), but now there is an offset between them of half the period of the drive train non-uniformity (90). This condition will have observable banding at the small hub gear tooth frequency greatly reduced.

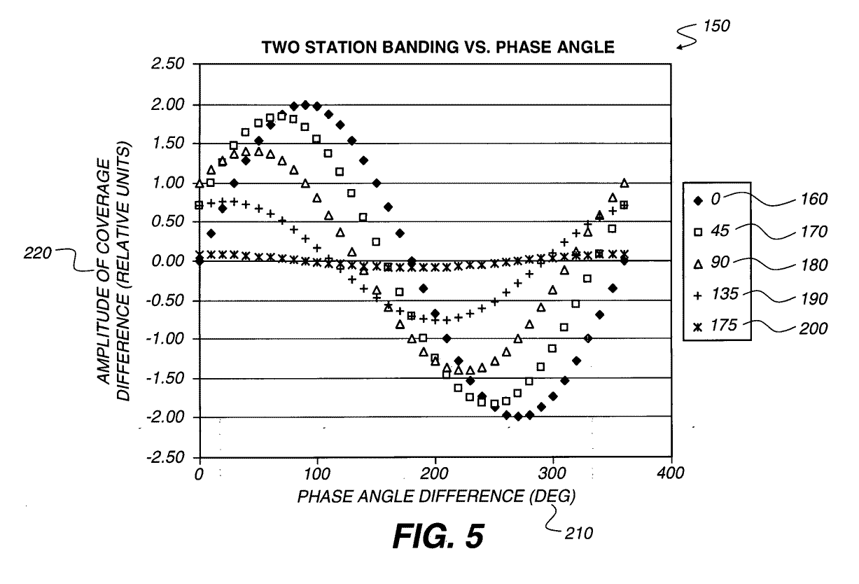

FIG. 5 shows a graph of the predicted banding amplitude at the small hub gear tooth frequency vs. the relative phase angle between the small hub gears for a 2 color image. The predicted banding performance at 0° phase angle is shown by data (160) in the figure. Similarly, data labeled (170) is the predicted performance at 45° phase angle, data labeled (180) is at 90° phase angle, (190) is at 135° phase angle, and (200) is at 175° phase angle. Predictions here are relative amplitude of banding optical reflection density about a mean density level, assuming that the drive velocity has a sinusoidal variation. The x-axis of the graph (210) is the relative phase angle between the two colors. The y-axis of the graph (220) is the amplitude of the density variation about its mean value.

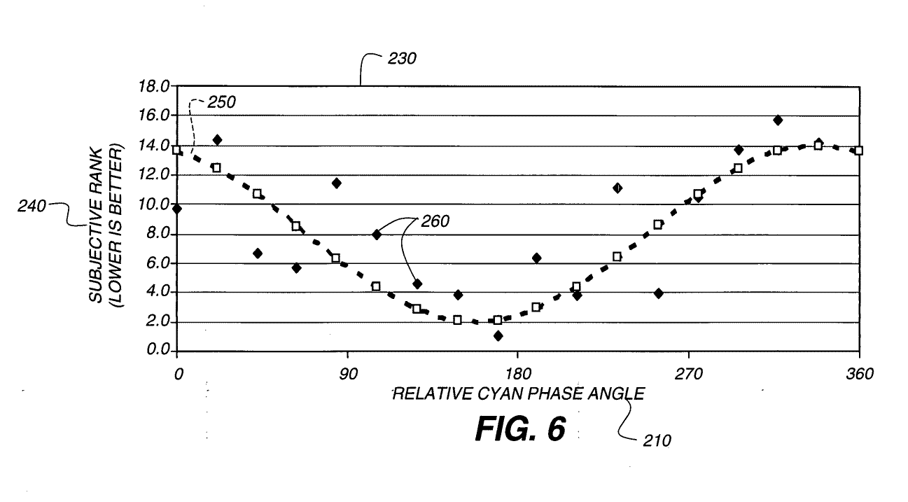

FIG. 6 shows a graph of the actual subjective response to a series of multicolor prints with varying phase angle relationships between the cyan and magenta images. The x-axis (230) is the phase angle between the cyan and magenta small hub (50) gear teeth. The y-axis (240) is the average subjective rank assigned by subjective observers. The smooth curve (250) is the theoretical sinusoidal curve of FIG. 5 scaled to fit the subjective rank amplitude. The actual average subjective rank data points (260) are shown as filled diamonds. The phase variations were generated by rotating the cyan compound gear (20) a single tooth at a time on the outer sprocket relative to the rest of the drive train (10) and generating the test prints until each of the 17 unique phase relationships for the cyan small hub (50) teeth of the compound gear (20) had been represented. The prints generated were then ranked (by a series of subjective observers under controlled lighting conditions) from best (ranked as 0) to worst (ranked as 17) for the subjective banding at the small hub (50) tooth frequency. Statistical analysis of the results indicate that a difference of 4 ranking units between prints can be detected with 95% confidence in the data. Comparison of the theoretical scaled curve (250) and the data points (260) indicates good agreement between theoretical and actual results.

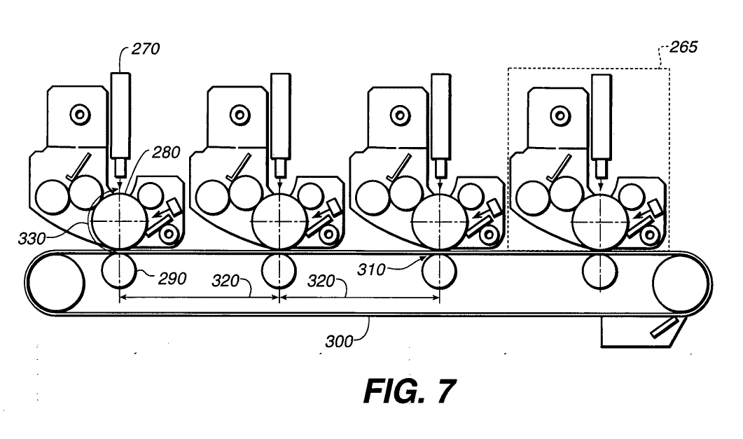

FIG. 7 shows a diagram of an exemplary multicolor EP printer showing features of interest for controlling phase angle between EP modules. This printer would typically use a drive train such as shown in FIG. 1 to drive the EP modules (265). Each EP module interfaces with an exposure source (270) shown here as an LED print-head array/lens assembly as is well known in the art. It could also be a laser scanning module, as is also well known. (280) is a photoconductive drum which receives the exposure from the exposure source (270) and converts the optical exposure pattern into an electrical charge pattern. A transfer roller (290) is used to physically transfer toned images (produced by any of a number of toning/developing technologies well known in the art) from the photoconductive drum (280) to receiver sheets (not shown, but well known in the art) using pressure and electrical bias (as is also well known in the art). The receiver sheets are carried by the transport belt (300) sequentially to each of the EP modules (265) to receive the images they produce at the transfer nips (310) formed between the photoconductive drums (280), the receiver transport belts (300) and the transfer rollers (290). In the printer, transfer nips are separated by distances (320). The distances around the photoconductive drum (280) circumference between exposure source and the transfer nip (310) are also identified (330).

The phase relationship between modules can be controlled and adjusted in a printer such as shown in FIG. 7 using the preferred method of compound gear rotation described in FIGS. 3-6 above. This allows the drivetrain to be symmetric, use identical modules, interfaces, and gears throughout and achieve the associated simplicity of assembly and associated cost reductions needed for a low cost multicolor printer.

The phase relationships between colors can also be controlled using the distances (330) for the two modules and (320) between the two modules as well as the relationships between the compound gears wherein 320n is the separation between the exposure source location on the photoconductor, such as a photoconductive drum, (n) and the transfer nip location on the photoconductor. Note that the photoconductor can be anything that can be imaged such as a drum, a belt or other image receptors on which a writer, such as a laser or LED, can write an image. The phase relationship from (330)₁ and (330)₂ and (320)_{1,2} can be determined by taking their sum for the pair of modules of interest and dividing by the pitch (P) determined in equation 1, subtracting the integer part of the result, dividing by (P), and multiplying the result by 360

θ_{(modules 1,2)}=[[{(330)₁+(330)₂+(320)_{1,2}}/P−INT({(330)₁+(330)₂+(320)_{1,2}}/P)]P]*360

The overall phase relationship will then be

θₒᵥₑᵣₐₗₗ=θ_{(gear teeth)}+θ_{(modules 1,2)}

Using (320) to control θₒᵥₑᵣₐₗₗ will cause EP modules (265) or their interfaces to the exposure sources (270) to differ module to module by color and would require a complicated mechanism to allow adjustment within the printer. This would increase the cost of the printer.

Using (330) would require the drive train (10) to become asymmetric, require the transfer nips to have different geometries, or require the use different idler gears (30) from module to module. It would also not allow for adjustment within the printer without a sophisticated mechanism inconsistent with an inexpensive printer.

A method for carrying out a print job with a digital electrophotographic printing machine includes controlling two or more print engines, including a photoconductor, having a shared drive assembly comprising at least two gears, a first gear comprising first gear teeth and a second gear comprising second gear teeth, each of which drives the photoconductor in a separate print engine wherein the first gear teeth and the second gear teeth are offset an offset value; accessing velocity variation information (known and set once) to set the relative locations of two or more gears, all driven by the same drive assembly; and setting a relative gear position of the first and second gear in relation to said drive assembly so that the two gears are out of phase to minimize the appearance of drive assembly tooth related velocity variations. The offset value is calculated using a ratio b/a where (a) is the distance between gear teeth on the small hub of one compound gear and (b) is the offset distance between the gear teeth on the small hubs of the two superpositioned compound gears as described above. The printer can include a monitoring device, interacting with the controller, to control printing based on the relative gear drive positions and/or other printer elements, such as the writer, registration system, sensor(s) and paper feed system. A positioning device can be incorporated to move the writer relative to the drive assembly and/or to move the writer relative to the transport belt which is driven independently to the drive assembly.

To facilitate these calculations and adjustments a computer program can be created and used to control a relative gear position of the first and second gear in relation to said drive assembly so that each gear is out of phase to minimize drive assembly tooth related velocity variations (correcting for drive non-uniformity banding). The computer program product could include the computer steps of generating a file of gear position information corresponding to one or more offset values, said record including the relative effects of the gear positions of at least two superpositioned compound, transferring the gear position information to the printer, possibly remotely controlling printing using the record, updating the record based on printing results; and updating the record during the above steps. The offset value can be calculated using a ratio b/a where (a) is the distance between gear teeth on the small hub of one compound gear and (b) is the offset distance between the gear teeth on the small hubs of the two superpositioned compound gears or by calculating or accessing phase angles.

The invention has been described in detail with particular reference to certain preferred embodiments thereof, but it will be understood that variations and modifications can be effected within the spirit and scope of the invention.

### PARTS LIST

10 drive train for a electrophotographic printer
20 compound drive train gear
30 idler drive train gear
40 large hub of compound drive train gear
50 small hub of the compound drive train gear
60 gear offset
70 phase angle
80 2 color in phase half tone pattern
90 period of drive train uniformity
100 location of high density bands
110 slowest velocity of drive non-uniformity for color 1
120 slowest velocity of drive non-uniformity for color 2
130 2 color 180° out of phase half tone pattern
140 offset of slowest velocity of drive non-uniformity for color 1 and color 2
150 graph of the predicted banding amplitude vs. the phase angle for a 2 color image
160 0° phase angle
170 45° phase angle
180 90° phase angle
190 135° phase angle
200 175° phase angle
210 phase angle axis
220 amplitude axis
230 phase angle axis
240 average subjective banding rank
250 fitted spline cure of subjective banding rank
260 actual subjective banding rank data points.
265 Individual EP modules
270 LED printhead exposure source
280 Photoconductive drum
290 transfer roller
300 receiver transport belt
310 transfer nip between transfer roller, paper transport belt, and photoconductive drum
320 transfer nip pitch, module to module
330 LED exposure to transfer nip separation

1. A digital electrophotographic printer for printing on a receiver, the printer comprising:
a. a gear drive assembly comprising at least two gears, a first gear comprising first gear teeth and a second gear comprising second gear teeth, each of which drives a photoconductor in a separate print engine wherein the first gear teeth and the second gear teeth are offset an offset value;
b. two or more print engines sharing the drive assembly, each print engine including imaging cylinder and a writer; and
c. a controller for controlling a relative gear position of the first and second gear in relation to said drive assembly so that the two gears are out of phase to minimize the appearance of drive assembly tooth related velocity variations.

2. The printer of claim 1, the offset value is calculated using a ratio b/a where (a) is the distance between gear teeth on the small hub of one compound gear and (b) is the offset distance between the gear teeth on the small hubs of the two superpositioned compound gears and their ratio b/a represents how much the two gears are offset relative to each other.

3. The printer of claim 2 wherein the offset value comprises a θ_{gear teeth}=b/a*360 (in degrees)=b/a*2Π(in radians).

4. The printer of claim 3 wherein the offset value comprises a θₒᵥₑᵣₐₗₗ=θ_{(gear teeth)}+θ_{(modules 1,2)} and θ_{(modules 1,2)}=θ_{(modules 1,2)}=[[{(330)₁+(330)₂+(320)_{1,2}}/P−INT({330)₁+(330)₂+(320)_{1,2}}/P)]/P]*360.

5. The printer of claim 1 further comprising a monitoring device, interacting with the controller, for controlling printing based on the relative gear drive positions.

6. The printer of claim 1 further comprising a positioning device to move the writer relative to the drive assembly.

7. The printer of claim 1 further comprising a positioning device to move the writer relative to the transport belt which is driven independently to the drive assembly.

8. A method for carrying out a print job with a digital electrophotographic printing machine comprising:
a. controlling two or more print engines, including a photoconductor, having a shared drive assembly comprising at least two gears, a first gear comprising first gear teeth and a second gear comprising second gear teeth, each of which drives the photoconductor in a separate print engine wherein the first gear teeth and the second gear teeth are offset an offset value;
b. accessing velocity variation information (known and set once) to set the relative locations of two or more gears, all driven by the same drive assembly; and
c. setting a relative gear position of the first and second gear in relation to said drive assembly so that the two gears are out of phase to minimize the appearance of drive assembly tooth related velocity variations.

9. The method of claim 8, the offset value is calculated using a ratio b/a where (a) is the distance between gear teeth on the small hub of one compound gear and (b) is the offset distance between the gear teeth on the small hubs of the two superpositioned compound gears and their ratio b/a represents how much the two gears are offset relative to each other.

10. The method of claim 9 wherein the offset value comprises a θ_{gear teeth}=b/a*360 (in degrees)=b/a*2Π (in radians).

11. The method of claim 10 wherein the offset value comprises a θₒᵥₑᵣₐₗₗ=θ_{(gear teeth)}+θ_{(modules 1,2)} and θ_{(modules 1,2)}=θ_{(modules 1,2)}=[[{(300)₁+(330)₂+(320)_{1,2}}P−INT({(330)₁+(330)₂+(320)_{1,2}}/P]/P]*360

12. The method of claim 8 further comprising a monitoring device, interacting with the controller, for controlling printing based on the aforementioned writer and relative gear drive positions.

13. The method of claim 8 further comprising a positioning device to move the writer relative to the drive assembly.

14. The method of claim 8 further comprising a positioning device to move the writer relative to the transport belt which is driven independently to the drive assembly.

15. A system for printing on a receiver, the printer comprising:
a. a gear drive assembly comprising at least two gears, a first gear comprising first gear teeth and a second gear comprising second gear teeth, each of which drives a photoconductor in a separate print engine wherein the first gear teeth and the second gear teeth are offset an offset value;
b. two or more print engines sharing the drive assembly, each print engine including imaging cylinder and a writer;
c. a registration device and sensors to detect images; and
d. a controller for controlling a relative gear position of the first and second gear in relation to said drive assembly so that the two gears are out of phase to minimize the appearance of drive assembly tooth related velocity variations.

16. The system of claim 15, the offset value is calculated using a ratio b/a where (a) is the distance between gear teeth on the small hub of one compound gear and (b) is the offset distance between the gear teeth on the small hubs of the two superpositioned compound gears and their ratio b/a represents how much the two gears are offset relative to each other.

17. The system of claim 16 wherein the offset value comprises a θ_{gear teeth}=b/a*360 (in degrees)=b/a*2Π (in radians).

18. The system of claim 17 wherein the offset value comprises a θₒᵥₑᵣₐₗₗ=θ_{(gear teeth)}+θ_{(modules 1,2)} and θ_{(modules 1,2)}=θ_{(modules 1,2)}=[[{(330)₁+(330)₂+(320)_{1,2}}/P−INT({330)₁+(330)₂+(320)_{1,2}}/P)]/P]*360

19. The system of claim 15 further comprising a monitoring device, interacting with the controller, for controlling printing based on the aforementioned writer and relative gear drive positions.

20. The system of claim 15 further comprising a positioning device to move the writer relative to the drive assembly.

21. The system of claim 15 further comprising a positioning device to move the writer relative to the transport belt which is driven independently to the drive assembly.

22. A computer program product for controlling a relative gear position of the first and second gear in relation to said drive assembly so that each gear is out of phase to minimize drive assembly tooth related velocity variations (correcting for drive non-uniformity banding), the computer program product comprising computer steps of:
a. generating a file of gear position information corresponding to one or more offset values, said record including the relative effects of the gear positions of at least two superpositioned compound;
b. transferring the gear position information to the printer;
c. remotely controlling printing using the record;
d. updating the record based on printing results; and
e. updating the record during steps a-d.

23. The program of claim 22, the offset value is calculated using a ratio b/a where (a) is the distance between gear teeth on the small hub of one compound gear and (b) is the offset distance between the gear teeth on the small hubs of the two superpositioned compound gears and their ratio b/a represents how much the two gears are offset relative to each other.

24. The program of claim 23 wherein the offset value comprises a θ_{gear teeth}=b/a*360 (in degrees)=b/a*2Π (in radians).

25. The program of claim 14 wherein the offset value comprises a θₒᵥₑᵣₐₗₗ=θ_{(gear teeth)}+θ_{(modules 1,2)} and θ_{(modules 1,2)}=θ_{(modules 1,2)}=[[{(330)₁+(330)₂+(320)_{1,2}}/P−INT({(330)₁+(330)₂+(320)_{1,2}}/P)]/P]*360.
